(19) United States
(12) Patent Application Publication
(10) Pub. No.: US 2025/0367579 A1
(43) Pub. Date: Dec. 4, 2025

(54) FULLY SUBMERSED BLOCK STYLE PRIMARY WATER FILTER

(71) Applicant: James Enterprise Inc., Pueblo, CO (US)

(72) Inventor: Gerard Klaes, Moab, UT (US)

(21) Appl. No.: 19/173,593

(22) Filed: Apr. 8, 2025

Related U.S. Application Data
(60) Provisional application No. 63/653,146, filed on May 29, 2024.
(60) Provisional application No. 63/653,151, filed on May 29, 2024.

(51) Int. Cl. B01D 29/56; B01D 29/11; B01D 35/153; B01D 35/157; B01D 35/30; B01D 39/20

(52) U.S. Cl. CPC B01D 29/56; B01D 29/114; B01D 29/117; B01D 35/153; B01D 35/1576; B01D 35/303; B01D 39/2055; B01D 2201/167; B01D 2201/291; B01D 2201/4038; B01D 2201/4092

(57) ABSTRACT

A water filter system including a primary container, a primary filter positioned in the primary container, a secondary container positioned below the primary container, a secondary filter in fluid communication with the primary filter and positioned in the secondary container, and a shell surrounding the sides and top of the primary filter.

### CROSS-REFERENCE TO RELATED APPLICATION

This application claims the benefit of and priority to U.S. Provisional Patent Application No. 63/653,146, filed May 29, 2024, and U.S. Provisional Patent Application No. 63/653,151, filed May 29, 2024, the disclosures of which are hereby incorporated herein by reference in their entireties.

### FIELD OF THE DISCLOSURE

The present disclosure relates to gravity-fed water filter systems having primary and secondary water filters, and more particularly to a fully submersed block style primary water filter.

### BACKGROUND

In some circumstances harmful contaminants can exist in tap water, for example. Municipal water treatment does not eliminate all risks, and aging infrastructure can introduce additional hazards. Contaminants like PFAS, lead, arsenic, fluoride, and industrial chemicals can exist in water supplies, leading to serious health issues such as cancer, hormonal disruptions, and organ damage.

Accordingly, many water filtration systems, such as gravity-fed water filter systems, have been developed to filter out many of the contaminants prevalent in water supplies. A gravity-fed water filter system uses gravity to draw water through filter media, filtering it without needing electricity or pumps. These systems typically have an upper chamber for unfiltered water and a lower chamber for storing the filtered water, which can be dispensed via a spigot.

### SUMMARY

In one implementation of the present disclosure, a water filter system includes a primary container, and a primary filter positioned in the primary container. A secondary container is positioned below the primary container and a secondary filter in fluid communication with the primary filter is positioned in the secondary container. A shell surrounds the sides and top of the primary filter.

In one example of this implementation, the primary filter includes a cylindrical body surrounding an internal cavity and an impermeable cap secured to a lower portion of the cylindrical body. In a second example, the shell includes one or more openings proximate a base of the shell and above the impermeable cap. In a third example, the shell includes one or more openings proximate a base of the shell and below a top edge of the impermeable cap. In a fourth example of this implementation, the one or more openings comprises an opening extending through a sidewall of the shell. In a fifth example, the one or more openings comprises a gap between the shell and the impermeable cap. In a sixth example of this implementation, the shell includes a one-way vent valve positioned at a top end of the shell. In a seventh example, the shell is removably attached to the primary filter. In an eighth example, the primary filter includes an internal cavity and is positioned in the primary container to allow water contained in the primary container to move from outside the primary filter, through the primary filter, and into the internal cavity of the primary filter. In a ninth example of this implementation, the primary filter includes a stem extending from the bottom of the primary filter in fluid communication with the internal cavity of the primary filter. In a tenth example of this implementation, the stem connects to an upper portion of the secondary filter whereby the stem is in fluid communication with an internal cavity of the secondary filter to allow water to flow from the primary filter into the internal cavity of the secondary filter and through the secondary filter. In an eleventh example, at least one of the primary and secondary filters comprises activated carbon.

In another implementation of the present disclosure, a water filter assembly includes a filter, having a cylindrical body surrounding an internal cavity and an impermeable cap secured to a lower portion of the cylindrical body. The impermeable cap includes an outlet stem in fluid communication with the internal cavity and a cylindrical shell surrounds the sides and top of the cylindrical body.

In one example of this implementation, the shell includes one or more openings proximate a base of the shell and above the impermeable cap. In a second example, the shell includes one or more openings proximate a base of the shell and below a top edge of the impermeable cap. In a third example of this implementation, the one or more openings comprises an opening extending through a sidewall of the shell. In a fourth example, the one or more openings comprises a gap between the shell and the impermeable cap. In a fifth example of this implementation, the shell includes a one-way vent valve positioned at a top end of the shell. In a sixth example, the shell is removably attached to the primary filter. In a seventh example of this implementation, the cylindrical body comprises activated carbon.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is an isometric view of a gravity-fed water filter system according to the disclosed technology;

FIG. 2 is a partially exploded isometric view of the gravity-fed water filter system shown in FIG. 1;

FIG. 3 is an isometric view isolating one set of the primary and secondary filter assemblies of the gravity-fed water filter system of FIGS. 1 and 2;

FIG. 4 is a partially exploded isometric view of the primary filter assembly shown in FIG. 3;

FIG. 5 is a partially exploded isometric view of the secondary filter assembly shown in FIG. 3;

FIG. 6 is a side view in cross-section of the secondary filter assembly shown in FIGS. 3 and 5; and

FIG. 7 is an isometric view of an adapter fitting and adapter washer for use with the secondary filter according to the disclosed technology.

Corresponding reference numerals are used to indicate corresponding parts throughout the several views.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

A variety of filtration media is available for reduction of substances such as fluoride and arsenic. One thing these media have in common is an improvement in reduction performance as dwell time increases. Conventional down-flow cartridges are susceptible to channeling of the media, which effectively over-exposes media in the area surrounding the water channels and under-exposes the remainder of the media. The over and under-exposure tends to lessen the efficacy of the filter, which results in more frequent replacement of the filter in order to achieve satisfactory contaminant reduction results. In addition, gravity and water flow tend to work together to direct media fines to the bottom of the filter, where the media fines may migrate through the filter screen or pad at the base of the post-filter and into the effluent water.

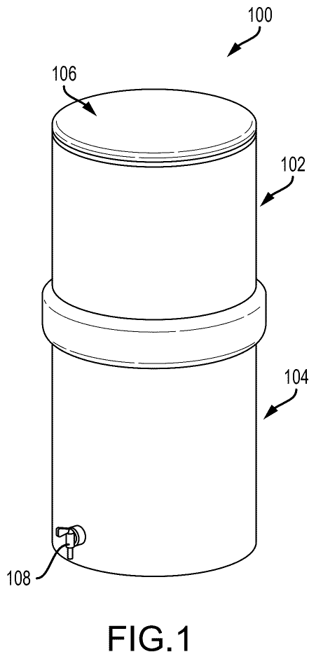

Disclosed herein is a unique approach to filter design that incorporates a fully submersed primary filter design and other improvements that address the shortcomings of conventional filter systems. Referring to FIG. 1, an implementation of a gravity-fed water filter system 100 can include an upper chamber, or a primary container 102, that sits on top of a lower chamber, or secondary container 104. The water filter system 100 can also include a lid 106 to cover the primary container 102. The primary container 102 and the secondary container 104 can be stacked on a stand (not shown) and the secondary container 104 can include a spigot 108 to conveniently dispense filtered water from the water filter system 100.

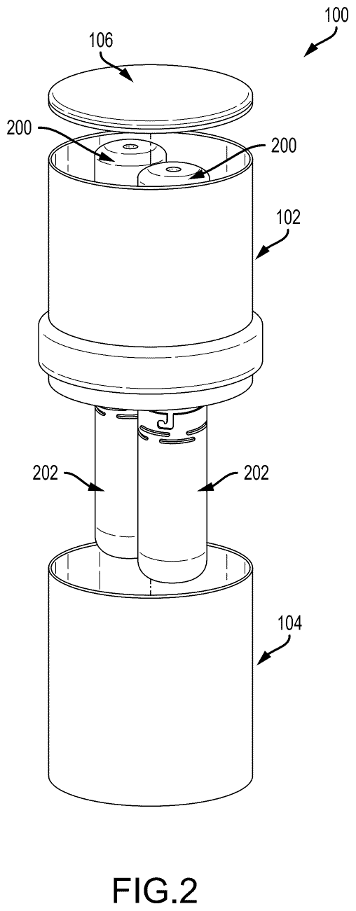

FIG. 2 shows a pair of primary filter assemblies 200 positioned in the primary container 102 and a pair of secondary filter assemblies 202 positioned in the secondary container 104. Each of the secondary filter assemblies 202 is in fluid communication with a corresponding one of the primary filter assemblies 200. In some implementations, the primary filter assembly 200 reduces a wide variety of contaminants as the water to be filtered flows from the primary container 102 through the primary filter assembly 200. The water flows from the primary filter assembly 200 into the secondary filter assembly 202 where it is further filtered as it flows through the secondary filter assembly 202 and into the secondary container 104 for collection. In some implementations, the secondary filter assembly 202 is designed to reduce or remove specific targeted contaminants present in the water coming from the primary filter assembly 202. Examples of such targeted contaminants can include arsenic and fluoride.

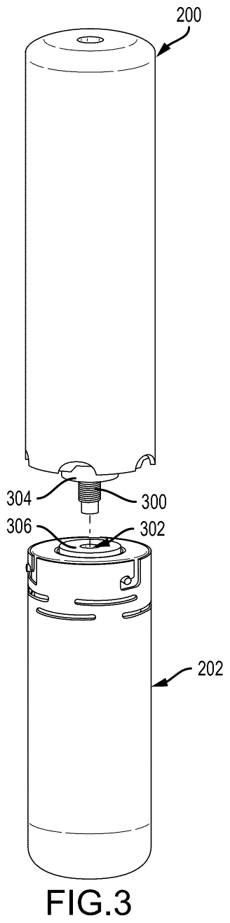

Referring to FIG. 3, the primary filter assembly 200 and the secondary filter assembly 202 screw together with mating male and female threads, 300 and 302, respectively. Both filter assemblies seal against the bottom of the primary container 102 with rubber washers 304 and 306, for example. The primary filter assembly 200 seals against a top side of the primary container 102 bottom and the secondary filter assembly 202 seals against a bottom side of the primary container 102 bottom.

As the filtered water passes into the secondary container 104, the water level in the primary container 102 declines, continually exposing less of the primary filter to the water as the water level declines. The declining water level in the primary container 102 can have several detrimental effects on the performance of conventional filtration systems. First, the flow rate decreases as the water level declines, due to the reduction in filter surface area exposed to the water, and due to the reduction in pressure to which the filter is exposed. Second, over the life of the filter, the lower portion of the filter is exposed to much more water than the upper portion of the filter. This over-exposure of the lower portion of the filter causes the lower portion of the filter to reach substance reduction saturation or end-of-life prior to the upper portion of the filter. The disclosed primary filter assembly 200 avoids these detrimental effects by exposing the entire filter to the water to be filtered throughout the entire filtration cycle.

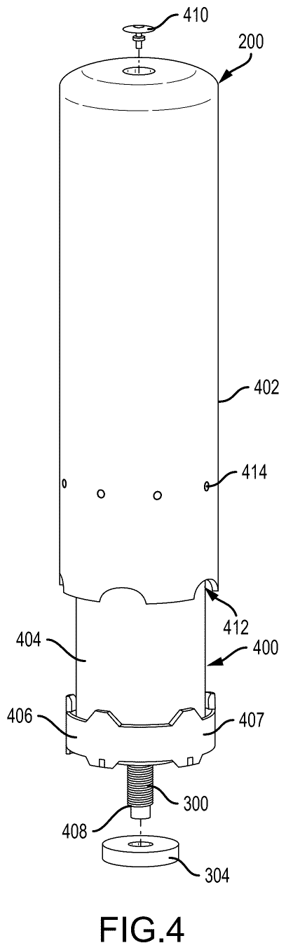

With further reference to FIG. 4, the primary filter assembly 200 includes a primary filter 400 and a shell 402 surrounding the sides and top of the primary filter 400. The primary filter 400 includes a cylindrical body 404 surrounding an internal cavity (not visible). The cylindrical body 404 is a filter element that can include activated carbon, for example. The primary filter 400 can include a cap 406 secured to a lower end portion of the cylindrical body 404. The primary filter 400 includes a stem 408 in fluid communication with the internal cavity of the primary filter 400. The stem 408 extends from the bottom of the primary filter 400 (i.e., extends from the cap 406).

In some implementations, the shell 402 is positioned over the cylindrical body 404 and snugly fits onto an outer circumferential surface 407 of the cap 406. As the primary container 102 is filled with water, the water flows between the filter 400 and the shell 402 via openings 412 and/or openings 414. In some implementations, the openings 412 lead to a gap between the impermeable cap 406 and the shell 402. The shell 402 can include a one-way vent valve 410 positioned at a top end of the primary filter assembly 200 to allow air that is initially trapped in the filter 400 and shell 402 to be vented as water displaces the air when the primary container 102 is filled with water.

As the primary container 102 is filled, the filtration process begins. When filling is complete, the water level in the primary container 102 begins to decline. As the water level in the primary container 102 declines, the shell 402 maintains full water level, until the water level in the primary container 102 nears the bottom of the primary container 102 and the base of the shell 402 and base of the primary filter 400. Thus, during the filtration process, the shell 402 maintains exposure of the entire surface of the primary filter 400 to water, from start to finish of the filtration cycle. The shell 402 remains full of water even as the water level in the primary container 102 declines because air is prevented from entering the shell 402 to displace the water. At this point, the filtration cycle is complete until the primary container 102 is refilled.

Depending on which openings 412 and/or 414 are provided at the base of the shell 402, the shell 402 may either allow or prevent air from once again entering the shell 402. Some filters may benefit from exposure to air in between filtration cycles, whereas other filters may benefit from constant exposure to water in between filtration cycles. Either of these two options may be achieved as explained below.

As water passes through the primary filter assembly 200, the water level in the primary container 102 decreases until the water level reaches the top of the impermeable cap 406. At that point, the water level no longer decreases, i.e., water no longer flows through the cylindrical body filter element 404. The water level in the shell 402 remains full unless air is allowed to enter the shell 402. By varying the position of the openings 412/414 in the shell 402 relative to the impermeable cap 406, air can either be allowed to enter the shell 402 or prevented from entering the shell 402.

For example, by employing openings 414 located above the level of the cap 406, air can enter the shell 402 when the water level in the primary container 102 approaches the top of the impermeable cap 406. Alternately, by only employing openings 412 located below the level of the cap 406 as perhaps best shown in FIG. 3, air is prevented from entering the shell 402 because the water level in the primary container 102 remains above the openings 412. Therefore, by choosing the location of the openings 412 or 414 in the shell 402, the shell can be configured to either allow or prevent air from entering the shell 402 at the end of the filtration cycle, depending on design intent with specific types of filters.

Additionally, the number and/or size of the openings in the housing can be varied to restrict water flow as desired. For example, substance reduction with certain types of filters can be improved by extending the contact time within the filter. By decreasing the number and/or size of the openings in the housing, water flow can be reduced, effectively increasing contact time between the water and the filter media.

The openings 412 located above the cap 406, can also limit the amount of filtered water entering the secondary container 104, to prevent over-filling of secondary container 104 under certain conditions. Such conditions may include the presence of an optional secondary filter in the secondary container 104 which occupies some volume that would otherwise be available for filtered water. In this case, a seal between the shell 402 and the cap 406 of the primary filter 400 would prevent further water migration between the primary container 102 and the secondary container 104 beyond the openings 412.

Comparison tests between the disclosed primary filter assembly 200 and conventional primary filters were conducted and the difference in performance was substantial. For example, when the primary container 102 was half full, the flow rate of the filter without a shell was approximately 60% the rate of the primary filter assembly 200 with the shell 402. As the primary container 102 water level declined further, the difference in performance was even more dramatic. When the primary container 102 had three inches of water remaining, the flow rate of the filter without the shell was approximately 25% the rate of the primary filter assembly 200 with the shell 402. A later check of flow rate at two inches showed that the filter without a shell had essentially stopped filtering, whereas the primary filter assembly 200 with the shell 402 continued to flow until the end of the filtration cycle, when air entered the cavity between the shell 402 and the primary filter 400.

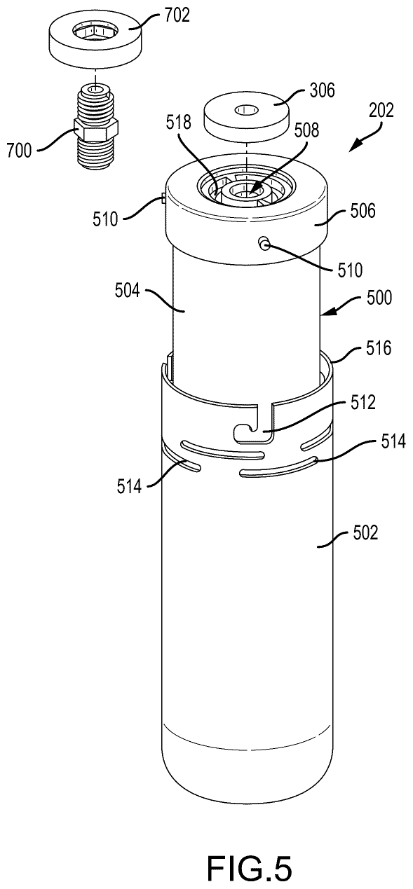

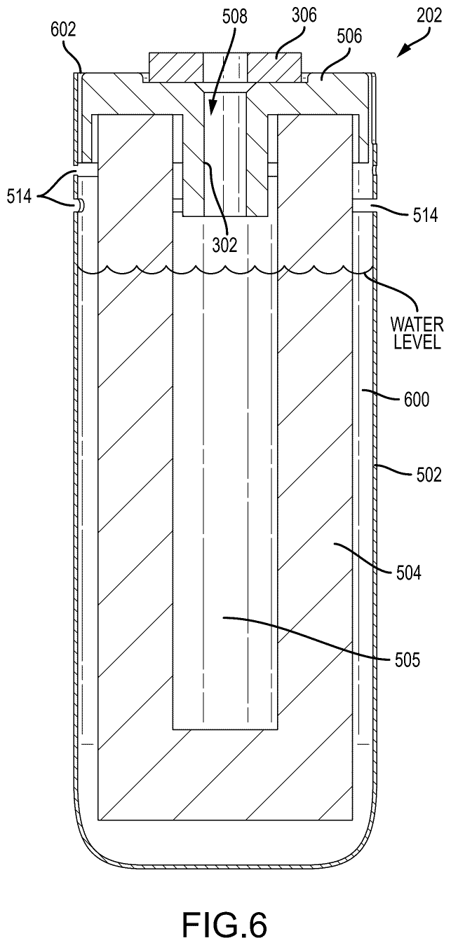

Moving to FIG. 5, the secondary filter assembly 202 includes a secondary filter 500 and a shell 502 surrounding the sides and bottom of the secondary filter 500. The secondary filter 500 includes a cylindrical body 504 surrounding an internal cavity 505 (FIG. 6). In some implementations, the cylindrical body 504 is a filter element that can include activated carbon, for example. The secondary filter 500 can include a cap 506 secured to an upper end portion of the cylindrical body 504. The cap 506 can include an inlet 508 in fluid communication with the internal cavity 505 of the secondary filter 500. In some implementations, the inlet 508 can include female threads 302 extending at least partially through the cap 506.

In some implementations, the shell 502 is removably attached to the secondary filter 500. As shown, the secondary filter 500 and the shell 502 are cylindrical, the secondary filter includes a radially extending protrusion 510, and the shell 502 includes a groove 512 positioned to engage the protrusion 510 and secure the shell 502 to the secondary filter 500. In some implementations, the radially extending protrusions 510 can be pins or posts and the grooves 512 can include an axially extending portion and a circumferentially extending portion. The secondary filter 500 can be inserted into the shell 502 with the protrusions first engaging the axial groove portion and then the circumferential groove portion as the filter is rotated with respect to the shell 502.

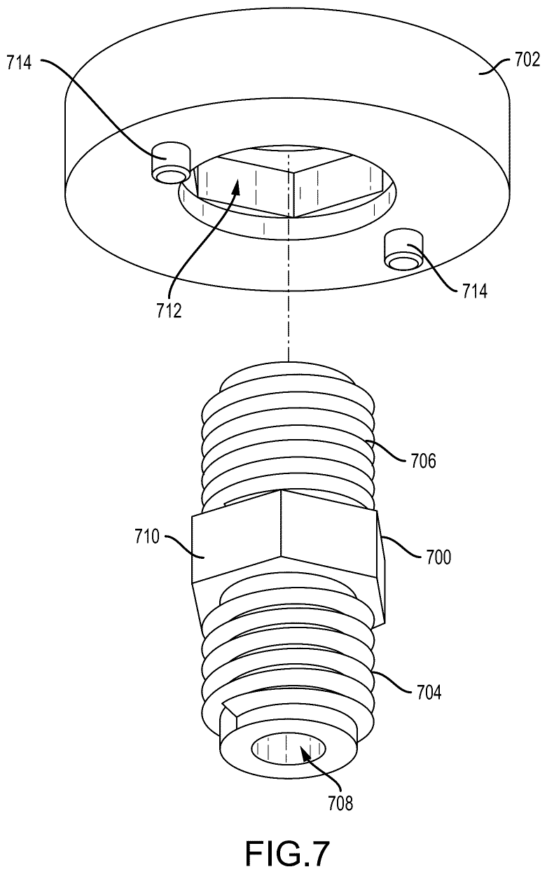

The shell 502 includes an outlet proximate an upper end 516 of the shell 502. In some implementations, the outlet comprises an opening 514 extending through the sidewall of the shell 502. In some implementations, the system 100, the secondary filter assembly 202, and/or the secondary filter 500 can be provided with adapters 700/702 to facilitate connecting the secondary filter 500 to a priming pump or other accessory, as described more fully below with respect to FIG. 7.

FIG. 6 is a cross-section of the secondary filter assembly 202. Water from the primary filter assembly 200 flows through the inlet 508 and into the internal cavity 505. The water then filters through the cylindrical body 504 and into the space 600 between the cylindrical body 504 and the shell 502. Filtered water fills this space 600 until the water level reaches the outlet openings 514 and flows out of the secondary filter assembly 202 and into the secondary container 104 for collection and storage. In some implementations, the filtered water can be allowed to flow out of the secondary filter assembly 202 through a gap 602 between the cap 506 and the shell 502, in leu of the openings 514.

With this unique design, the shell 502 and the internal cavity 505 of the secondary filter assembly 202 are always full of water. This ensures that the media in the secondary filter 500 is kept wet, so it does not lose its prime. As more water is added to the secondary filter assembly 202, the entirety of the secondary filter 500 is exposed to the additional water, ensuring that the media in the secondary filter 500 is exposed at a relatively constant rate across the entire vertical surface of the media.

Due to the more restricted flow path of down and through the secondary filter 500, then up and out the holes 514 in the shell 502, the dwell time is increased. Increases in dwell time further improve filter life. In addition, the fines from the filter are less likely to flow out of the holes 514 located in the upper end 516 of the shell 502, instead collecting in the bottom of the shell 502.

Lab testing has determined that the improvements described above result in a net improvement in filter reduction capacity. The lab test results show an improvement in reduction capacity with the up-flow design of the secondary filter assembly 202 versus a down-flow design. Even though the up-flow filter contained less media (210 ml vs 250 ml or 84%), the net fluoride reduced was nearly identical (1189.3 mg vs 1196.9 mg). Thus, the net media reduction capacity demonstrated in this test increased from 4.4 mg fluoride per gram of media to 5.1 mg fluoride per gram of media, approximately a 16% improvement.

In some implementations, the system 100, the secondary filter assembly 202, and/or the secondary filter 500 can be provided with adapters to facilitate connecting the secondary filter 500 to a priming pump. For example, as shown in FIG. 7, the adapters can include a male-to-male thread adapter fitting 700 to engage with the female threads 302 of the secondary filter 500. The adapter fitting 700 can include a first set of threads 704 sized and configured to mate with the threads 302 of the secondary filter 500 and a second set of threads 706 to mate with a priming pump or other accessory. In some implementations, the second set of threads 706 can be the same as the threads 300 of the primary filter 400. The adapter fitting 700 also has a fluid passage 708 extending axially therethrough.

The adapter fitting 700 can work in conjunction with a cylindrical adapter washer 702 positioned on the adapter fitting 700. The adapter washer 702 includes a central opening 712 shaped to mate with a corresponding feature 710 of the adapter fitting 700. For example, the adapter fitting 700 can include a hexagonal shaped portion 710 that mates with the central opening 712. Axially extending protrusions 714 (e.g., pins or posts) are positioned to engage a corresponding feature 518 of the secondary filter 500. The adapter washer 702 helps ensure that the adapter fitting 700 remains with the secondary filter 500 when the filter is unscrewed from a priming pump, for example. The hexagonal shaped portion 710 and the mating central opening ensure that the adapter fitting 700 and the cylindrical adapter washer 702 rotate together. The protrusions 714 engage with the secondary filter 500 ensuring that both the adapter washer 702 and adapter fitting 700 rotate with the secondary filter 500.

Although the disclosed technology is described herein with respect to gravity-fed water filtration systems having primary and secondary filters, other filter system configurations can employ the disclosed technology. For example, systems having more or fewer filter stages (e.g., one or three filter systems) and pressurized systems (e.g., pump fed systems), to name a few, can employ the disclosed technology.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. A water filter system, comprising:
a primary container;
a primary filter positioned in the primary container;
a secondary container positioned below the primary container;
a secondary filter in fluid communication with the primary filter and positioned in the secondary container; and
a shell surrounding the sides and top of the primary filter.

2. The water filter system of claim 1, wherein the primary filter includes a cylindrical body surrounding an internal cavity and an impermeable cap secured to a lower portion of the cylindrical body.

3. The water filter system of claim 2, wherein the shell includes one or more openings proximate a base of the shell and above the impermeable cap.

4. The water filter system of claim 2, wherein the shell includes one or more openings proximate a base of the shell and below a top edge of the impermeable cap.

5. The water filter system of claim 4, wherein the one or more openings comprises an opening extending through a sidewall of the shell.

6. The water filter system of claim 4, wherein the one or more openings comprises a gap between the shell and the impermeable cap.

7. The water filter system of claim 1, wherein the shell includes a one-way vent valve positioned at a top end of the shell.

8. The water filter system of claim 1, wherein the shell is removably attached to the primary filter.

9. The water filter system of claim 1, wherein the primary filter includes an internal cavity and is positioned in the primary container to allow water contained in the primary container to move from outside the primary filter, through the primary filter, and into the internal cavity of the primary filter.

10. The water filter system of claim 9, wherein the primary filter includes a stem extending from the bottom of the primary filter in fluid communication with the internal cavity of the primary filter.

11. The water filter system of claim 10, wherein the stem connects to an upper portion of the secondary filter whereby the stem is in fluid communication with an internal cavity of the secondary filter to allow water to flow from the primary filter into the internal cavity of the secondary filter and through the secondary filter.

12. The water filter system of claim 1, wherein at least one of the primary and secondary filters comprises activated carbon.

13. A water filter assembly, comprising:
a filter, including:
a cylindrical body surrounding an internal cavity; and
an impermeable cap secured to a lower portion of the cylindrical body, wherein the impermeable cap includes an outlet stem in fluid communication with the internal cavity; and
a cylindrical shell surrounding the sides and top of the cylindrical body.

14. The water filter assembly of claim 13, wherein the shell includes one or more openings proximate a base of the shell and above the impermeable cap.

15. The water filter assembly of claim 13, wherein the shell includes one or more openings proximate a base of the shell and below a top edge of the impermeable cap.

16. The water filter assembly of claim 15, wherein the one or more openings comprises an opening extending through a sidewall of the shell.

17. The water filter assembly of claim 15, wherein the one or more openings comprises a gap between the shell and the impermeable cap.

18. The water filter assembly of claim 13, wherein the shell includes a one-way vent valve positioned at a top end of the shell.

19. The water filter assembly of claim 13, wherein the shell is removably attached to the primary filter.

20. The water filter assembly of claim 13, wherein the cylindrical body comprises activated carbon.
